(19) United States
(12) Patent Application Publication
(10) Pub. No.: US 2008/0122970 A1
(43) Pub. Date: May 29, 2008

(54) Image capture device

(76) Inventor: Hsiao-Chi Lin, Taipei City (TW)

Correspondence Address: Troxell Law Office Pllc;Suite 1404, 5205 Leesburg Pike, Falls Church, VA, 22041, US

(21) Appl. No.: 11/481,946

(22) Filed: Jul. 7, 2006

(30) Foreign Application Priority Data
Jun. 14, 2006 (TW) 095121129

(51) Int. Cl. H04N 5/225

(52) U.S. Cl. 348/373; 348/E05.024

(57) ABSTRACT

The present invention provides an image capture device, capable of holding business cards and capturing images of business cards, comprises a base, having an image frame grabber provided thereon; a light-transmitting holder, disposed on the base; at least one extension unit, disposed between the base and the holder, having an end of the extension unit pivotally connected to the base and another end of the extension unit pivotally connected to the holder. In this way, the holder enables the to-be-image captured business card to become installed thereon in an opposite direction such that the image frame grabber is properly aligned with the pre-arranged capture face of business cards. Moreover, through the stretching action of the extension units, the holder is maintained at a suitable focal length from an image frame grabber disposed on the base such that the image frame grabber can clearly capture an image of business cards.

### BACKGROUND OF THE INVENTION

(a) Field of the Invention

The present invention relates to an image capture device, more particularly, to an image capture device that is capable of locating business cards for prearranged production and maintaining the business cards at a suitable focal length from an image frame grabber such that image information of the business cards can clearly be recorded and stored through the image frame grabber.

(b) Description of the Prior Art

In today's business world, business cards are important for social purposes. When people first meet, they exchange business cards, which have recorded the card-owners' company names, personal names, job titles, corporate service items, telephone number, E-mail address, address and a lot of background information. In summary, business cards can enhance the understanding of the other party, their relationship and even their trust in and respect for the other party for social and business purposes.

Because of continuous social exchanges, more business cards will be collected, reflecting a gradual increase in social assets. However, ordinary business cards are made of paper such that they will easily become damaged and lost if they are not properly kept. In this way, they are often found to have been lost or so badly damaged that they cannot be recognized until they are to be read. Moreover, in today's society, this is considered an act of bad manners or may even affect friendship if these cards are lost or damaged later.

To overcome the above problems, a great variety of card holders have been market launched for users to properly keep business cards. Several small, independent spaces have been designed on each page of card holders for the users to put business cards such that the collected cards are no longer scattered disorderly and damaged but can be kept orderly.

However, there are some drawbacks inherent in the aforementioned conventional card holders:
1. Due to a limited capacity of card holders, excessive business cards exceed the capacity of conventional card holders.
2. Due to the large size of card holders, it is not easy to find a specific business card if the cards are kept in several card holders.

Along with technological progress and the universal use of digital. peripheral products, some people try to overcome the above drawbacks by “photographing” an image of business cards through scanners, providing the image in a digital data format and storing the image in a CD or computer harddisk. However, scanners are not easily portable because of the large size. In this way, it is not possible to scan and store new business cards immediately such that they may be lost or damaged before they are made into a digital data format.

### SUMMARY OF THE INVENTION

To overcome the abovementioned drawbacks, the primary object of the present invention is to provide an image capture device that is capable of locating business cards for prearranged production and maintaining the business cards at a suitable focal length from an image frame grabber such that image information of business cards can clearly be recorded and stored through the image frame grabber.

To achieve the above object, the present invention comprises a base, having an image frame grabber provided thereon; a light-transmitting holder, disposed on the base; at least one extension unit, disposed between the base and the holder, having an end of the extension unit pivotally connected to the base and another end of the extension unit pivotally connected to the holder.

Referring to the above structure, the holder enables the to-be-image captured business cards to become installed thereon in an opposite direction, such that the image frame grabber is properly aligned with the pre-arranged capture face of the business cards. Moreover, through the stretching action of the extension unit, the holder is maintained at a suitable focal length from an image frame grabber disposed on the base such that the image frame grabber can clearly capture an image of the business cards.

To enable a further understanding of the said objectives and the technological methods of the invention herein, the brief description of the drawings below is followed by the detailed description of the preferred embodiments.

### BRIEF DESCIPTION OF THE DRAWINGS

FIG. 1 shows a perspective assembly view of the present invention.

FIG. 2 shows an exploded perspective view of the present invention.

FIG. 3 shows a side view of the present invention.

FIG. 4 shows a schematic view of the present invention.

### DETAILED DESCRIPTION OF THE PREFERRED EMBODIMENTS

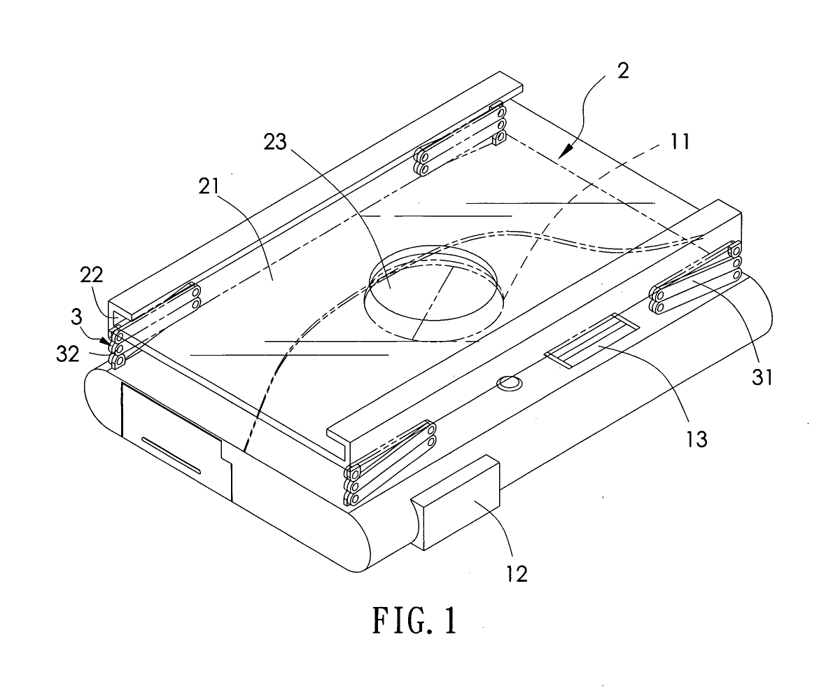

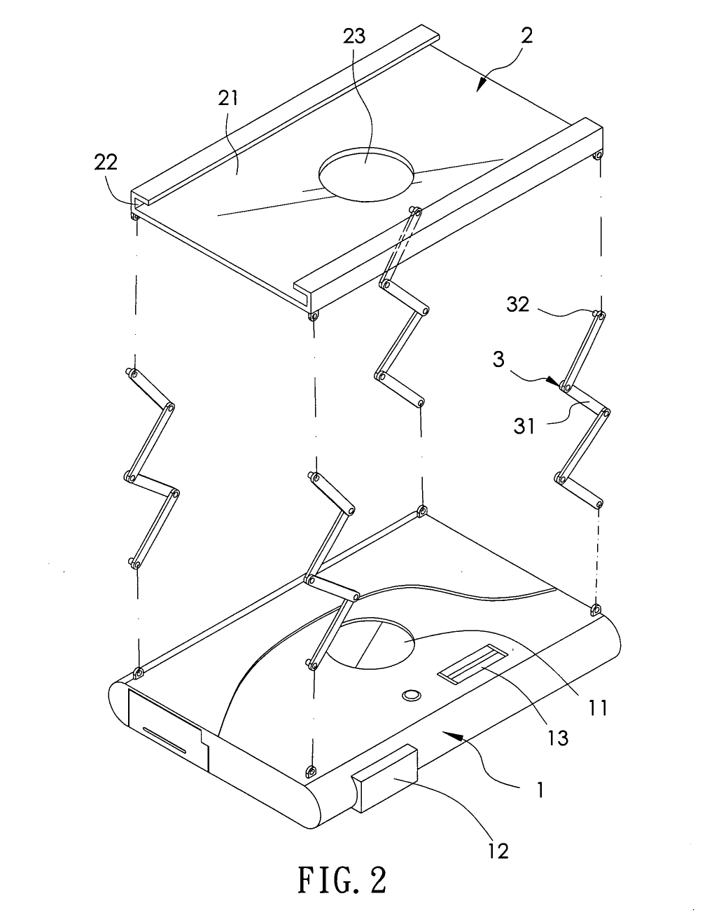

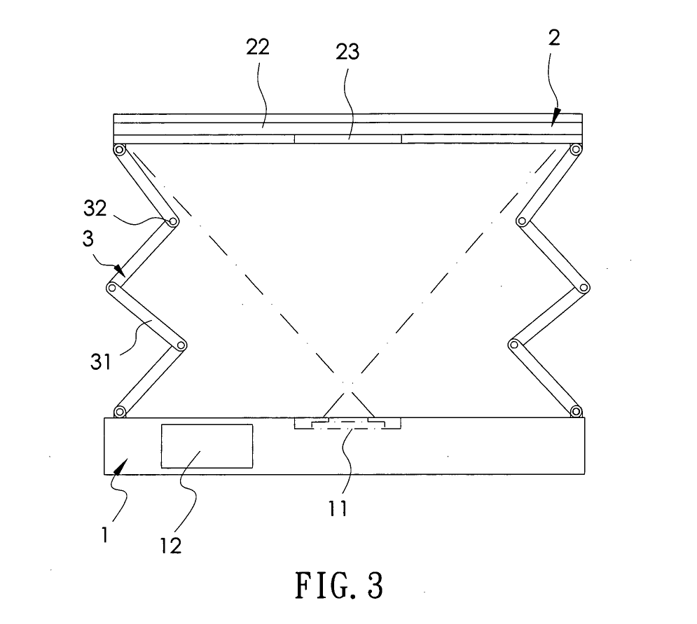

Referring to FIG. 1, FIG. 2 and FIG. 3, the present invention comprises a base 1, a holder 2 and four sets of extension units 3.

The base 1 has an image frame grabber 11, which is a digital camera, provided thereon. A control unit 12 is provided on a side end of the base 1 to control the image frame grabber 11 and an auxiliary illumination unit 13, which is a flash light, is provided on the base 1.

A holder 2, disposed on the base 1, is made of light-transmitting materials and comprises a light-transmitting plate body 21, such that the plate body 21 is pervious to light. A guide rail 22 is provided on the two opposite sides of the plate body 21 and a through hole 23 is opened on the plate body 21 to correspond with the image frame grabber 11.

The four sets of the extension units 3 are disposed between the base 1 and the holder 2. An end of each of the extension units 3 is pivotally connected to each of the four corners on a top face of the base 1; another end of each of the extension units 3 is pivotally connected to each of the four corners on a bottom face of the holder 2. Each extension unit 3, being configured in a connecting rod structure, comprises a plurality of rods 31 pivotally connected to one another by a plurality of short axes 32.

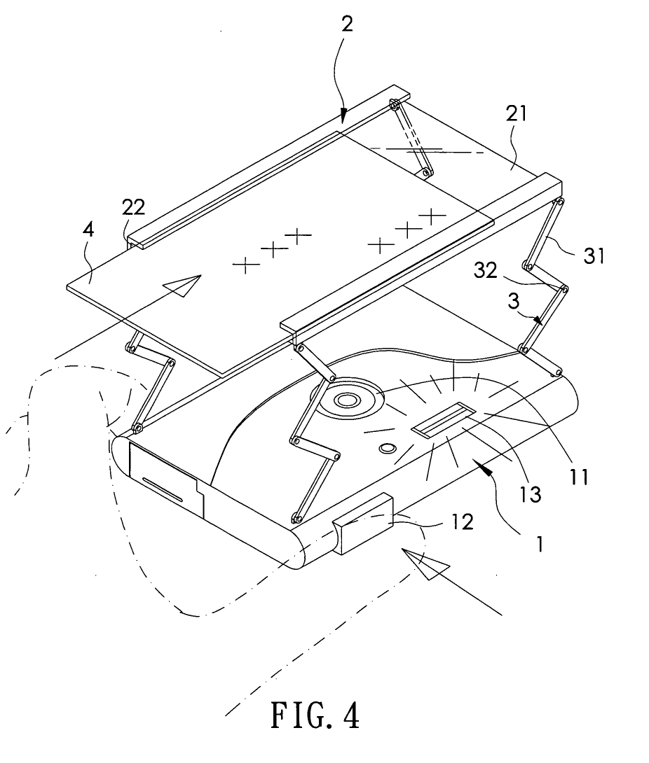

Referring to FIG. 1, FIG. 2, FIG. 3 and FIG. 4, the present invention can be folded into a thin profile by means of the rods 31 of the extension units 3 such that they are easily portable. When receiving a new business card 4, the to-be-image captured business card 4 becomes installed on the holder 2 in an opposite direction along the guide rail 22 provided on the two opposite sides of the plate body 21. Through the stretching action of the plurality of the rods 31 disposed on each of the extension units 3, the holder 2 is maintained at a suitable focal length from an image frame grabber 11 disposed on the base 1 such that the image frame grabber 11 can clearly capture an image of the business card 4. In this way, the user enables the image frame grabber 11 to capture a clear image of the business card 4 and store the image into a digital data format just by starting the control unit 12. In case of insufficient illumination when capturing the image, an auxiliary illumination unit 13 can be employed as an auxiliary light source when the image frame grabber 11 is capturing an image of the business card 4, such that the image of the image-captured business card 4 can be stored in a suitably illuminated data format in computers, personal digital assistants (PDAs) and other digital displays.

Referring to the above embodiments, the advantages of the present invention are given as follows:
(1) The present invention can be folded into a thin profile by means of the rods 31 of the extension units 3 such that they can be put in a pocket of a user's clothes and easily portable.
(2) Through the guide rail 22 provided on the two opposite sides of the plate body 21, the present invention can locate the business card 4 for prearranged production, preventing the recorded image of the business card 4 from being tilted and lowering the failure rate of image recording.
(3) Through the stretching action of each extension unit 3, the business card 4 can be maintained at a suitable focal length from an image frame grabber 11 such that image information of the business card 4 can clearly be recorded and stored through the image frame grabber 11.
(4) The present invention is installed with an auxiliary illumination unit 13, which can be started in case of insufficient illumination when capturing the image, such that the image of the image-captured business card 4 can be stored in a suitably illuminated data format.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An image capture device, capable of holding business cards and capturing images of business cards, comprising:
a base, having an image frame grabber provided thereon;
a light-transmitting holder, disposed on the base;
at least one extension unit, disposed between the base and the holder, having an end of the extension unit pivotally connected to the base and another end of the extension unit pivotally connected to the holder; wherein
the holder enables the to-be-image captured business card to become installed thereon in an opposite direction; through the stretching action of the extension unit, the holder is maintained at a suitable focal length from an image frame grabber disposed on the base such that the image frame grabber can clearly capture an image of the business card.

2. The image capture device as claimed in claim 1, wherein an auxiliary illumination unit is provided on the base.

3. The image capture device as claimed in claim 2, wherein the auxiliary illumination unit is a flash light.

4. The image capture device as claimed in claim 1, wherein a control unit is provided on a side end of the base to control the image frame grabber.

5. The image capture device as claimed in claim 1, wherein the image frame grabber is a digital camera.

6. The image capture device as claimed in claim 1, wherein four sets of the extension units are disposed on each of the four corners on a top face of the base.

7. The image capture device as claimed in claim 1, wherein each of the extension units is configured in a connecting rod structure.

8. The image capture device as claimed in claim 7, wherein each of the extension units comprises a plurality of rods pivotally connected to one another by a plurality of short axes.

9. The image capture device as claimed in claim 1, wherein the holder comprises a plate body having a guide rail provided on the two opposite sides of the plate body.

10. The image capture device as claimed in claim 9, wherein a through hole is opened on the plate body to correspond with the image frame grabber.
